(19) United States
(12) Patent Application Publication
(10) Pub. No.: US 2004/0191525 A1
(43) Pub. Date: Sep. 30, 2004

(54) Micro-fibrous polytetrafluoroethylene resin and process for making multi-directional planar structures

(76) Inventor: Robert Roberts, Ocala, FL (US)

Correspondence Address: EDWARD M. LIVINGSTON, ESQ., 628 ELLEN DR., P.O. BOX 1599, WINTER PARK, FL, 32790, US

(21) Appl. No.: 10/401,995

(22) Filed: Mar. 27, 2003

(51) Int. Cl. F26B 3/30; B27J 5/00; B28B 1/26

(52) U.S. Cl. 428/421; 264/86; 264/127; 264/320; 264/324; 264/87; 264/492

(57) ABSTRACT

A process for producing unmelted fibrous polytetrafluoroethylene (PTFE) resin from which multi-directional planar oriented structures such as sheets and planar shapes can be readily fabricated. Unfilled forms as well as filled and reinforced products are achievable. Novel composite-plied structures or unsintered sheets can be built by layering two (2) or more sheets containing functional fillers or reinforcements and then sintering said layers to provide a homogenous bond between all layered sheets. True reinforcement of formed fluoropolymer structures can be produced with tensile properties, which exceed the strength of virgin products. Microporous asymmetric membranes, which have decreasing pore size in a series of plies can be readily fabricated.

### BACKGROUND OF THE INVENTION

This invention relates to polytetrafluoroethylene resin and, more particularly, a process for producing mircofiborous PTFE resin in unmelted form for use in fabricating multi-directional planar oriented structures, such as sheets.

Since the discovery of PTFE (also known as Teflon) in April of 1938 by Plunkett of DuPont, methods of fabrication have slowly developed due to the unique and different properties of the material. The extremely high molecular weight and lack of melt flow of PTFE resin relative to other well-known plastic materials is to be blamed for the slow growth. The unfamiliar behavior of PTFE resin as a melt-processable plastic material forced fabricators to look elsewhere for processing help. Fabrication techniques gradually evolved around methods employed in the processing of powdered metals. This trend continued well into the 1950's and 1960's when melt-processable resins were developed and became commercially available. The molecular weight of these resin types had to be drastically lower to accomplish the desired melt flow for extrusion. Many of the beneficial virtues of the higher molecular weight PTFE resins were lost in the melt flow resins developed. In addition, melt process resins do not lend themselves to compounding with fillers and reinforcements.

In the early 1950's, major modifications in PTFE resin particle structure occurred to make particle flow and handling less difficult and make the finished product much more reproducible. However, changes in the basic fabrication methods did not change.

In the late 1950's and 1960's, research uncovered improved fabrication methods for PTFE resins. U.S. Pat. No. 3,556,161 issued to Robert Roberts, the present inventor, on Jan. 19, 1971 disclosed only the method for fabricating sheet, with emphasis on filled compositions.

The equipment required to manufacture the products disclosed in the Roberts patent was unfamiliar to the plastics industry and would require considerable capital and know-how to produce.

Currently, sheets made of PTFE resin are manufactured by compression molding. A virgin PTFE sheet is made by skiving a compression-molded cylinder of granular resin held in a lathe. This is done much the same as wood is shaved in the manufacture of plywood. A manufacturing problem arises because of the massive size of the required billet (the molded cylinder). Fluoropolymers, such as PTFE, all have a very narrow safety range for melting and sintering. Above the upper safe limit, the PTFE polymer degrades very rapidly and decomposition accelerates as the temperature exceeds that safe limit. In addition, all fluoropolymers possess very low thermal conductivity and require long sintering cycles to accomplish fusion. Thermal degradation frequently occurs because of the low thermal conductivity of the PTFE and the lack of needed temperature control during the long sintering cycles required. Even if heating is well controlled, too rapid heating or cooling can result in cracked billets and polymer waste. Sintering cycles often require a full day and are energy intensive. The density of the sintered billet can vary widely from the inside to the outside as well as at either end of the billet. The variations in density which occur are reflected in skived sheet and cause it to warp so it will not lay flat. The skived sheet also retains the memory of its origin in the billet; the result is a sort of sine wave in the sheet when an attempt is made to lay the sheet flat. In order to obtain a flat sheet, the sheet must be subjected to reheating above its remelting point of 327 degrees Centigrade to re-crystalize the resin and equalize sheet density and remove the retained warp stresses held in the sheet. To accomplish flatness the sheet is confined between metal plates and re-sintered above its melt transition temperature. The process for obtaining useable flat sheet as well as billet molding is time and energy intensive. Waste is of the order of 10 to 15 percent (10 to 15%) in trimmings from the ends of the billet and polymer adjacent to the skiving mandrel.

The compression molding billet process for making PTFE-filled sheets has proven to be impractical for many reasons. The molding and sintering steps must be performed in the confines of the billet mold under high pressure. A quality filled composition above 30 percent (30%) is not commercially available. Dulling of the skiving blade by the fillers becomes a major problem. Currently, only granular molding grade PTFE is usable in the billet molding process as coagulated dispersion resin cannot be processed.

Another method for manufacturing biaxially-oriented structures, such as sheets, was disclosed in Roberts U.S. Pat. No. 3,556,161, cited above, known as the biaxial calendaring method. This method involves the application of concurrent compressive and shear stresses to lubricated PTFE coagulated dispersion resin particles. The application of compressive and shear stress components in processing are directed so that the component vectors result in a biaxially-oriented planar orientation in the fabricated article. However, the Roberts '161 patent is based on the use of coagulated dispersion resin only. Each coagulated dispersion particle 500 micron average diameter contains a plurality of loosely held spherical-shaped dispersion particles with an average dispersion particle size of 0.2 microns. A thin film of coagulum forms a container for the dispersion particles. When the 500 micron aggregate particles are wet with a liquid that spreads on a PTFE resin surface, the wetting liquid penetrates 500 micron coat allowing the 0.2 micron spherical particles to move freely within the 500 micron sack or container. This freedom of movement in lubricant allows the particle to be worked, i.e., extruded or calendared. Art process attempts to employ water as a carrier medium has always failed. Water is hydrophobic to the fluoropolymer surfaces and will not wet or penetrate the 500 micron particle. Water is employed to form the original dispersion coagulum because it causes the particles to aggregate, thus forming the 500 micron coagulated particle. The Roberts '161 patent is concerned most importantly with the dispersion particles contained within the coagulum skin or outer coating of the 500 micron coagulum particle.

PTFE granular resins were excluded from the process disclosed in the Roberts '161 patent because the entire particle is a heterogeneous spongy contiguous construction roughly 500 microns average particle size and not workable. When comminuted, the above particle size is reduces to approximately 50 microns plus, yielding a substantial portion of mechanically-produced resin fibers or disclosed in U.S. Pat. No. 2,936,301, issued to Thomas, et al. on May 10, 1960. The latter product is currently made in a pelletized form in a process disclosed in U.S. Pat. No. 3,766,133, issued to Roberts et al. on Oct. 16, 1973, and marketed by DuPont under the name “Teflon 7”.

The process described in this invention has many of the mechanical characteristics of paper-making. However, in paper-making the starting materials are usually cellulosic fibers or similar materials processed in a water medium. Fibers made from wood pulp must be pre-processed to become free fibers from the solid timber. The wood is reduced to a pulp by a comminuting and beating process that frees the fibrous material. The reduction to pulp and the further processing are all processed in a water medium. Polytetrafluoroethylene resin has historically been manufactured in particulate form to deliberately avoiding any tendency to produce fibers. This was done because all of the methods of processing employed in industry require symmetrical particles with good handling characteristics, namely to be free-flowing and capable of being delivered to a narrow mold cavity for automatic molding as well as capable of leveling uniformly where a shallow sheet mold is required. Fluoropolymer manufacturers felt that the only way to produce a quality sheet product would depend upon their development of a melt-processable resin type.

Two attempts were made to paper-make coagulated dispersion polymer, disclosed in U.S. Pat. No. 3,003,912, issued to Hartford on Oct. 10, 1961, and U.S. Pat. No. 3,010,950, issued to Thomas on Nov. 28, 1961, both of which attempted to make a PTFE coagulated dispersion powder suitable for calendaring into sheet. Hartford produced processable fibers by paste extruding coagulated dispersion powder lubricated with 20 percent (20%) “Skellysolve E” (a petroleum fraction) to produce rod containing fibered polytetrafluorothylene. After the one-eighth inch (⅛″) diameter rod was dried, it was cut into one quarter (¼) to one inch (1″) lengths. It was found that by rubbing rod segments together vigorously in a micro-pulverizer or hammer mill the segments would shred to produce a fibered form. The fibers thus extracted were processed in a water medium according to customary paper-making art. When the felt-like product produced was fused by sintering at 350 to 370 degrees Centigrade, the sheet shrank to 40 percent (40%) of its previous area prior to drying. The product produced was found to be air permeable and similar to paper.

Thomas describes a process in which coagulated dispersion resin particles are “water-cut” in a high-speed bladed cutter. Cutting is continued until a major portion of the particles are deformed into what is described as “bola-shaped” particles. The powder produced above, according to the teachings, can be calendared into sheet. This patent claims only a polytetrafluorothylene fine powder form. Both of the above patents utilize water as a processing medium. Water is hydrophobic to fluoropolymers and will cause the resin to clump or aggregate. The fact that water does not wet fluoropolymers hinders processing and the forming of pore-free structures. A quality product was never produced utilizing the Hartford or Thomas methods.

### SUMMARY OF THE INVENTION

The primary object of the present invention is to provide an improved process for producing sheet and filled composition structures of PTFE resin.

A further object of the present invention is to produce such structures that have multi-directional planar oriented stability.

Another object of the present invention is to provide products made with PTFE with better resistance to wear and corrosion and with superior tensile strength and formability elongated without yield, reduced creep under load, improved friction and wear resistance and a two (2) to three (3) fold increase in flax for fatigue life.

The present invention fulfills the above and other objectives by converting PTFE resin particles to a fiberous structure by applying high-velocity shearing forces to the PTFE resin in a wetting liquid, preferably Isopar H, at a temperature of approximately 125 degrees for approximately three (3) to five (5) minutes to produce a slurry. Then, the slurry is further diluted in additional wetting liquid to separate the micro-fibers and form a homogeneous mixture of micro-fibers. The homogeneous mixture of micro-fibers is then deposited onto a porous surface to remove the liquid and form a mat of PTFE fibers. Then, the mat is dried at a temperature not exceeding the melting temperature of PTFE, which is 342 degrees Centigrade. The mat is then compressed at moderate pressure under 1,000 PSI at a temperature ranging between 175 to 342 degrees Centigrade. Finally, the sheet of PTFE micro-fibers is sintered at a temperature of approximately 380 degrees for approximately thirty (30) minutes to one (1) hour to form a fused sheet of PTFE micro-fibers. The step of depositing the micro-fibers on a porous surface is preferably assisted by a vacuum of 25 to 28 inches of mercury. The drying step is normally performed in an air circulating oven or under a bank of infrared heaters. The compression step is normally accomplished between two (2) smooth metal plates. The resulting multi-directional structure of micro-fibrous PTFE resin may be filled with a filler such as calcium carbonate, mica, or silicon carbide micro particles between multiple sheets and can be fused during sintering to form a composite structure.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a photomicrograph of “Teflon” 7 fibers produced by the present invention in shear at a moderate temperature of 100 degrees Centigrade;

FIG. 2 is a photomicrograph of “Teflon” 7 fibers produced by the present invention at 150 degrees Centigrade;

FIG. 3 is a photomicrograph of “Teflon” 6 coagulated dispersion resin fibers produced by the present invention at 125 degrees Centigrade;

FIG. 4 is a photomicrograph of “Teflon” 6 fibers produced by the present invention at 200 degrees Centigrade; and

FIG. 5 is a perspective view showing the formation of the “fiber mat” before heating to form the PTFE resin sheet.

### DESCRIPTION OF THE PREFERRED EMBODIMENTS

The following explanation of terms used in this description will be helpful in understanding the invention.

Fiber Mat—Non-woven fibers which are randomly interlocked to form a mat.

Multi-Directional Planar Orientation—All fibrous materials (including PTFE fibers) are oriented multi-directional in the x-y plan of the surface and lie parallel in the “z” (thickness) plane in layers. This orientation is characteristic of this method of processing fibrous materials and most importantly, but not exclusively, of the PTFE fibers produced as a key part of this invention. In filled and reinforced sheet produced, as a product of this invention the fibrous PTFE portion of the composite becomes the matrix material for all material additives.

Wetting Liquid—The contact angle of water with PTFE surface is approximately 108 degrees. Consequently, water beads on a PTFE surface, i.e., does not wet the PTFE. In contrast, the contact of Isopar H on a PTFE surface is “0”, i.e., it spreads and wets the PTFE surface.

Melting Point—PTFE displays two (2) melting points. Virgin PTFE (never melted previously) melts at 342 degrees Centigrade. Once melted and then cooled the melting point will be 327 degrees Centigrade upon reheating to the melt.

All PTFE resin types employed in the examples of this invention are DuPont “Teflon” resins. All PTFE resins processed by this invention are virgin-type, i.e., have never been previously sintered. “Teflon” is DuPont's trademark for all fluoropolymer resins. Some examples of DuPont PTFE coagulated dispersion resin types are “Teflon” 6, 6c, and 60. Granular types are “Teflon” 7, 7A, and 7C. “Teflon” 9B is a granular resin, but is pre-melted and therefore not acceptable. Other manufacturers of PTFE follow: Asahi Glass is trademarked “Fluon”. The Ausimont trademark is “Algoflon”. Daikin fluoropolymer resins are marketed in the United States of America by Sumitomo trademarked as “Neoflon”. All of the above resin types may be employed in this invention provided they are PTFE coagulated dispersion resins or granular PTFE resins, which have not been previously melted.

This novel invention recognizes the need for processing in a lyophilic liquid that will wet fluoropolymer surfaces freely. Wetting prevents polymer from sticking together. The wetting liquid lubricates and permits the particulate resin to be drawn into fibers by the forces of streamline flow produced by the shearing forces in a high speed blender. The diameter and length of the fibers produced are a function of temperature, blade tip geometry, speed, liquid viscosity, wetting, and the characteristics of the blender-type employed.

The mechanism by which the spherical 0.2 micron dispersion particles are transformed into fiber form cannot be explained. The fiber diameters are often less than the 0.2 micron size found in dispersion form. The total length of the fibers is most frequently significantly longer than 0.2 microns. It might be postulated that the spherical dispersion particles are balls of molecules that unravel under the streamlined shear conditions produced during the fiber forming process of the invention. Once the fibering and blending process has been completed, the homogenous randomly distributed diluted fiber containing slurry is spread uniformly onto a fine mesh screen or similar surface to remove the liquid component. Liquid removal may be facilitated by the use of a vacuum in either a batch or a continuous process such as employed in industrial paper-making. The “fiber mat” formed is flexible and easily handled and can be completely dried by heating in a batch oven or in a continuous process by banks of infrared heaters. The drying process must be applied with care so that the drying temperature does not exceed the melt transition temperature of the fluoropolymer resin of 342 degrees Centigrade. All material processed up to and including the drying step may be recycled without a loss of final product quality. Recycling can be a significant cost savings especially where products must be die cut from the dried mat, as will be shown later. Once the product has been formed and dried, it may be sintered by heating in an oven or if produced as a continuously formed “fiber mat” by a bank of infrared heaters. Dried “fiber mat” is very versatile and flexible. It can be plied to produce a greater thickness or the plies may contain different compositions of fibered materials, such as fillers and/or added reinforcements. Layers may have different functional purposes such as thermal or electrical conductivity and special frictional properties. Porous polytetrafluorothylene structures can be produced by the inclusion of sized fillers such as calcium carbonate or sodium chloride, which can be leached from the sheet after sintering. Such structures can be utilized as micro-porous asymmetric fluoropolymer membranes. Composite product possibilities are unlimited as a result of plying layers of unsintered product, which facilitates the bonding of the plies. The composite is compressed under moderate pressure with the application of heat below the resin melt transition temperature to consolidate and form the composite. Pressure below 1,000 PSI is usually adequate. The temperature of the plies for consolidation is usually no greater than 300 degrees Centigrade and can be as low as 100 degrees Centigrade. Consolidation will not be successfully achieved if the melt transition temperature of the fluoropolymer resin is exceeded prior to consolidation. After consolidation, the composite structure can be free sintered above the 342 degree Centigrade fluoropolymer melt transition temperature.

Where the desired finished article has a special shape such as in gasketing or in the manufacture of friction discs, bearing pads, etc., the object can be die cut from the dried “fiber mat” and then processed and finally free sintered individually. After cutting to the desired shape, all of the left over “fiber mat” can be recycled back through the blending process without loss of product quality. Pipe or tubular products can be produced by multiple wraps of “fiber mat” around a mandrel until the desired wall thickness is achieved. The mandrel defines the inner diameter of the tube. The plies produced by wrapping can be consolidated by the application of hydrostatic pressure as employed in isostatic molding, but at greatly reduced pressure. The finished product produced will possess multi-directional planar orientation. If employed as a part of an isostatic molding process, the problems encountered in mold filling will no longer exist.

The novelty and key to the success of this invention lies in the discovery of a simple process for producing unmelted fibrous polytetrafluorothylene resin from unmelted resin mold in a powder.

First, fiber is produced by high speed streamline shearing forces in a 125 degree Centigrade wetting liquid, Isopar H, in three (3) to five (5) minutes.

The fibrous resin slurry produced is very bulky and requires considerable ambient temperature Isopar H dilution (20 to 35 parts) enough to provide a free-flowing homogeneous slurry.

Second, the homogeneous slurry is then poured uniformly onto a porous mold surface under a vacuum of twenty-five (25) to twenty-eight (28) inches to remove Isopar H and form a flexible “fiber mat” until the liquid has been substantially removed. A multi-directional planar orientation of PTFE polymer has been very simply produced after the fibers settle.

Third, all traces of Isopar H in the “fiber mat” are removed by drying the mat at 125 degrees Centigrade in an air-circulating oven or under a suitable bank of infrared heaters. In no instance can the “fiber mat” exceed the 342 degree Centigrade melt transition temperature.

Fourth, to form a flat, smooth surface, the formed “fiber mat” is heated to 175 degrees Centigrade and compressed at 500 PSI pressure for one (1) minute between smooth surface metal plates.

Finally, the formed sheet is free sintered at 380 degrees Centigrade for thirty (30) minutes to one (1) hour. After sintering, the sheet lays flat and is form stable. Physical properties performed on the sheet are essentially equal over the entire sheet surface no matter how the samples are cut.

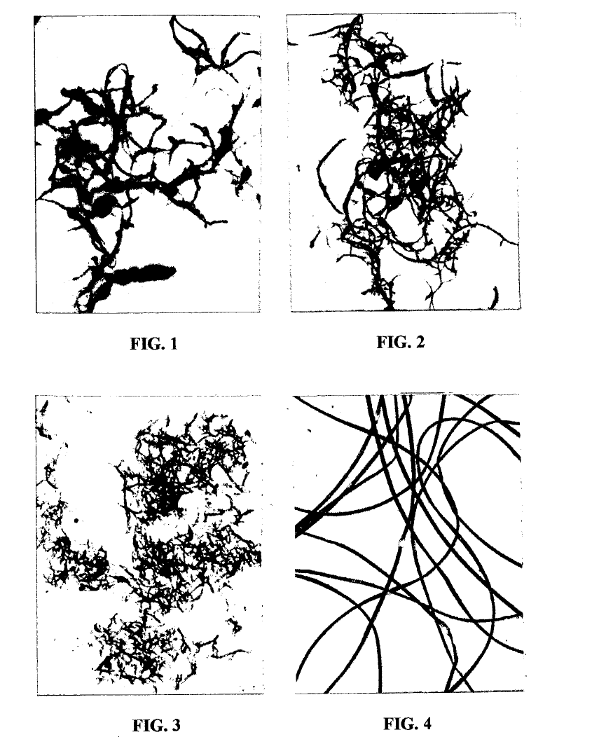

The liquid medium employed in the streamlined shearing step of this process shown in FIGS. 1, 2, and 3 is Isopar H. The liquid medium employed in FIG. 4 was “Fluorolube” high temperature fluorocarbon oil. The shear conditions employed were significantly reduced. FIG. 4 shows the wide range of conditions possible and the very significant differences in the extent of fibered structures possible.

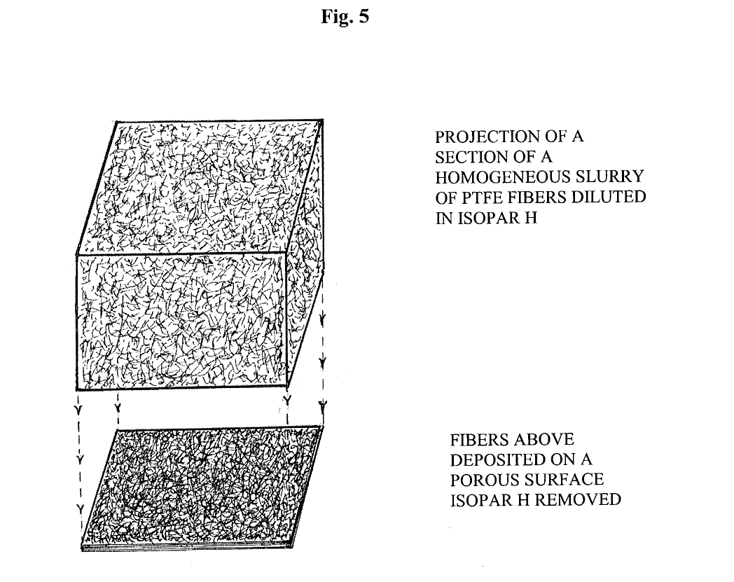

FIG. 5 shows the “fiber mat” before heating to form the PTFE resin sheet, unsintered fibrous polytetrafluorothylene resin randomly suspended in Isopar H to form a highly diluted homogeneous slurry being deposited on a porous surface to remove the Isopar H to form a multi-directional planar oriented “fiber mat” with fiber axis oriented essentially parallel to the plane of the sheet surface.

Resin suppliers other than DuPont, for example Ausimont, Ashai Glass, Daikin, and Sumitomo, as well as other equivalent resins, may provide the PTFE fluoropolymer resins employed in this invention.

Fiber additions other than Silicon carbide whiskers, glass and Fiberfrax might also be added or substituted. For example, carbon, graphite, Kevlar 29 or Kevlar 49, Avimid K or Avimid N, DuPont FP fiber, and 3M Nextel.

Microscopic particles of copper, bronze, lead, and other temperature stable compounds, such as sodium tetraborate (borax). Microscopic platelets such as mica, glass, and aluminum are a few particulate forms of interest.

Opportunities in the realm of super-conductivity may offer interesting opportunities for alloying metals and oxides, such as Y—Ba—Cu—O.

Articles made by this technology should have applications in fuel cells for use as cation-exchange membranes, embossed anode and cathode plates, conductive sheet and supports or binders for catalytic particles. Uses in battery technology particularly in air cathode zinc cell constructions may be possible.

It is postulated that other unmelted fluoropolymers might be plasticized by heat and the penetration of a wetting liquid so that high intensity streamline shear might produce micro fibers similar to those demonstrated by this invention. Other candidate unmelted fluoropolymer resins such as PFA, FEP, ECTFE, and PVDF among others may be candidates.

It is known that particulate forms of other crystalline high molecular weight polymers are contained within the raw unmelted particulate polymerized resin. These high molecular weight linear chain structures may be held loosely similar to the polytetrafluoroethylene particulate chains of this invention. High intensity shear, in a wetting liquid, may separate these chains and produce fibered resin similar to the forms seen in this invention. In the event that fibers can be processed from other polymers, this would open an entirely new processing field to discovery. Some very interesting synergistic results may be possible by blending different polymeric fiber chains that are intimately intertwined and may possibly cross-link so that they cannot be separated. Some polymer types with very interesting unique properties are polyether ether ketones, polysulfones, polyamides, polyarylene ketone, polyphenylene sulfide, polyamid-imide, polyetherimide, and polyimides. Processing of polymers other than fluoropolymers to form fibers may be possible. Most melt processable crystalline polymers are polymerized as powders or fluff and must be consolidated and degassed before being melted and reconstituted as molding cube. In order to achieve this void-free, technique such as vacuum melting are employed to remove entrapped air and eliminate air voids in the melted product.

The following examples illustrate how the present invention can be employed to produce PTFE resin sheets for use in various applications.

### EXAMPLE I

This example illustrates the processing of coagulated dispersion polytetrafluoroethylene resin to produce sheet by this invention. Twenty (20) parts of Isopar H hydrocarbon oil (Exxon) are added to one (1) part of “Teflon” 6 (DuPont) coagulated dispersion resin (having an average particle size of 500 microns) in a high intensity stirrer. The two (2) components are mixed for three (3) minutes at a temperature of 125 degrees Centigrade producing a heaving slurry of fibered particles. The particles produced are one quarter inch (¼″) to three eighths inch (⅜″) long with average diameters ranging from five (5) to thirty (30) microns. The thick slurry is diluted further with thirty-five (35) parts of ambient temperature Isopar H and stirred an additional forty-five (45) seconds to produce a thinned homogeneous slurry. The thinned slurry is poured into a twelve inch by twelve inch (12″×12″) paper mold (containing a Whatman No. 1 filter paper). A vacuum of approximately twenty-five inches (25″) of mercury is applied to settle the particles and remove the liquid component and form a “fiber mat”. The “fiber mat” is dried further at 125 degrees Centigrade in an oven to volatilize all remaining Isopar H. The thoroughly dried “fiber mat” is then compressed at a pressure of approximately 500 PSI at a temperature of 175 degrees Centigrade to provide a 0.030 inch thick sheet with a smooth surface. The sheet is then free sintered for one (1) hour in an oven at 380 degrees Centigrade. The above sheet had an average tensile strength of 4,500 PSI and an average elongation of 350 percent.

### EXAMPLE II

This example illustrates the processing of granular polytetrafluoroethylene resin to produce sheet by this invention. Twenty (20) parts of Isopar H hydrocarbon oil are added to one (1) part of “Teflon” 7 (DuPont), this resin is claimed to have a substantial portion of mechanically-produced fibrous polytetrafluoroethylene particles, Thomas et al., U.S. Pat. No. 2,936,301 and Roberts et al., U.S. Pat. No. 3,766,133. The Isopar H and “Teflon” 7 are mixed for four (4) minutes at a temperature of 125 degrees Centigrade to produce a heavy slurry of fibered particles. The particles produced are up to one-quarter inch (¼″) length with average diameters of ten (10) to sixty (60) microns. The thick slurry is further diluted with thirty-five (35) parts of ambient temperature Isopar H and stirred for an additional one (1) minute to produce a thinned homogeneous slurry. The thinned slurry is processed further as in Example I. After sintering, the resulting sheet has an average tensile strength of 5,000 PSI and an average elongation of 325 percent.

### EXAMPLE III

This example illustrates the processing of a fibrous ceramic component with granular polytetrafluoroethylene resin to produce a sheet by this invention. Thirty (30) parts of Isopar H are added to one (1) part of solids composed of thirty percent (30%) “Fiberfrax” manufactured by the Carborundum Company (Sohio Engineering Materials Company) and seventy percent (70%) “Teflon” 7. “Fiberfrax” is the trade name for a fibered ceramic composed of 53.9 percent by weight of silica and 43.4 percent by weight of alumina with a melting point of 1,790 degrees Centigrade it possess superior corrosion resistance, high resistance to oxidation and reduction and complete resistance to moisture. “Fiberfrax” has a high aspect ratio of 200 to 1,000 often included in friction and filtration applications as well as for the reinforcement of plastics. The processing continues as in Example II. The finished 0.030 inch thick sheet composition has an average tensile strength of 2,200 PSI and an average percent elongation of 170 percent.

### EXAMPLE V

This example demonstrates the utility of the composition of Example IV. At the conclusion of the drying step in Example IV, a portion of the dried “fiber mat” is die cut to produce a ring six inches (6″) I.D. and eight inches (8″) O.D. The die cut ring is placed in a heated mold which contains a bottom plate with a raised face embossing pattern. The pattern in this case is a grooved helix with intersecting radiating grooves every sixty (60) degrees. The raised pattern of the embossing tool is half rounded and has a radius of approximately fifteen thousands of an inch. The mold with embossing pattern facing up is heated to approximately 260 degrees Centigrade. The die cut “fiber mat” is placed in a mold. A silicon rubber caul 0.025 inch thick is placed on top of the “fiber mat” followed by the top metal compression ring. A pressure of 2,000 PSI is applied for one (1) minute and then the silicone rubber caul is removed and the compression ring returned. The mold is closed for fifteen (15) seconds and 2,000 PSI pressure is applied for fifteen (15) seconds. The last step flattens any raised areas on the backside of the molded part as well as the part. The embossed part is removed from the mold. The embossed grooves remain accurately replicated in the part. The embossed part is free sintered in an air-circulating oven for thirty (30) minutes at 380 degrees Centigrade. Sintering has not altered the dimensions of the part and the grooves imparted by the embossing tool are accurately replicated in the part. The grooved disc 0.030 inch thick is to be one (1) of six (6) like parts to become a facing on metal components for a clutch pack utilized in heavy equipment such as earth movers manufactured by Caterpillar Tractor Company and the like. Such clutch pack surfaces are wetted with high temperature heat transfer liquids that are circulated through the pack to remove the heat generated by the friction of engagement. The grooves in the facing help to reduce the heat generated on the friction generating surface. The clutch facings by this invention were bonded to one (1) surface of each disc. In order to bond the facing of the metal disc, the backside of the facing produced was chemically etched employing a sodium complex etchant (available commercially) and then bonded to the metal clutch disc with an epoxy-phenolic adhesive sold by Raybestos-Manhattan. A heavy equipment manufacturer tested a pack of six (6) discs in a torture test to find surprisingly positive performance and endurance. Laboratory tests were also performed on an inertia-stop testing apparatus. The presentation showed smooth engagement and disengagement which is highly desirable in heavy equipment. The clutch-facing bond has high resistance to torque and the facing long resistance to wear.

### EXAMPLE VI

This example demonstrates the ability of the art to manufacture a product similar to Example V. The art processes have been unable to mold thin filled composition particularly fibered materials. Molded parts are extremely fragile because resins and fillers and particularly fibers will not cohesively bond even when attempts to preform are made at extremely high pressure. Thin sheet would by necessity be made by skiving (shaving) a billet (cylinder) in a lathe. Skiving would be prohibitive because “Fiberfrax” would dull the skiving blade. The pattern embossed in the molded clutch facing material is embossed by coining. Coining is accomplished by heating the filled sintered sheet above the 342 degree melt temperature of the PTFE resin and compressing the embossing pattern into the sheet to replicate the patter. The finished coined sheet does not have dimensional stability and the embossed pattern is not accurately replicated due to shrinkage and warping.

### EXAMPLE VII

This example outlines the equipment needs to implement a continuous process for producing the product according to this invention. For mixing and blending scale-up, Kayd Mill manufactures a high intensity blender under the trade name “Kaydissolver”, that was found to be suitable for the fiber manufacturing and the blending step. The forming steps can be accomplished by equipment available from Sandvik Process Systems, of Totowa, N.J., who are capable of providing equipment for paper-making and all other steps that are needed to process sheet continuously according to this invention.

### EXAMPLE VIII

This example describes a method of producing novel functional layered structures by the process of this invention. A sheet is produced as described in Example IV except that the “Fiberfrax” content is replaced by one (1) part of XPW2 silicon carbide whiskers as produced by J. M. Huber Corporation, of Borger, Tex. The sheet produced is not sintered, but is dried, then put aside for further processing. A second sheet is processed as in Example I. The sheet is not sintered after drying but is put aside for further processing. A third sheet is processed as in Example III only the solids portion of one (1) part consists of thirty percent (30%) of “Teflon” 7, forty percent (40%) of “Teflon” 6, and thirty percent (30%) of “Crystolon” green silicon carbide flour 4647 manufactured by The Norton Company, of Worcester, Mass. Once the sheet has been dried, it is put aside for further processing. The three (3) dried sheets are plied so that the first sheet is on the bottom; the second sheet is then added, followed by the third sheet. The three (3) plied sheets are then heated to 150 degrees Centigrade allowing sufficient time to reach temperature (approximately 15 minutes). When the plied sheets are at temperature, a pressure of 500 PSI is applied and held for approximately fifteen (15) seconds. The compressed plied structure is then transferred to a sintering oven at 380 degrees Centigrade and free sintered for thirty (30) minutes, then removed from the oven and air cooled to room temperature. The composite structure is 0.090 inches thick, has smooth surfaces, and lays flat. Plied surface number one (1) containing silicon carbide whiskers provides an outer reinforced multi-directional planar structure of both PTFE tetrafluoroethylene and silicon carbide for strength, abrasion resistance, and improved thermal conductivity. The second plied layer is multi-directional planar oriented for strength while the last multi-directional planar oriented ply affords corrosion resistance and abrasion resistance as well as improved thermal conductivity. Silicon carbide is selected because it has chemical resistance which essential parallels the performance of the fluoropolymer component, but has improved thermal conductivity and the whiskers provide improved strength.

### EXAMPLE IX

This example demonstrates the inventions use in manufacturing asymmetric porous integral membranes for use in filtration in the electronics and pharmaceutical industries. Twenty (20) parts Isopar H are added to one (1) part of solids of which twenty percent (20%) is “Teflon” 6 and eighty percent (80%) is calcium carbonate, the pore the former, having an average particle size of ten (10) microns. The two (2) components are mixed for three (3) minutes in a high shear cutter operating at a peripheral speed of 2,000 feet per minute at a temperature of 125 degrees Centigrade to produce a heavy slurry. The heavy slurry is diluted further with thirty-five (35) parts of ambient temperature Isopar H and stirred for an additional forty-five (45) seconds to produce a thinned homogeneous slurry. The thinned slurry is poured into a twelve inch by twelve inch (12″×12″) paper mold containing a Whatman No. 1 filter paper. A vacuum of approximately twenty-five inches (25″) of mercury is applied to settle the solids and remove the liquid component and form a “fiber mat”. The “fiber mat” is dried in an oven set at one hundred (100) to two hundred (200) degrees Centigrade to remove all traces of Isopar H. The sheet is set aside. A second sheet is prepared using the same procedure as above, only the particle size of the calcium carbonate is five (5) microns average particle size. After drying the sheet is set aside. A third sheet is prepared using the same procedure only the calcium carbonate is two (2) to three (3) microns average particle size. After drying, the sheet is set aside. The three sheets are now plied according to ascending average particle size. The plied sheets are then heated to 175 degrees Centigrade and compressed at 500 PSI to bond the plies. The plied composite is then free sintered at 380 degrees Centigrade for thirty (30) minutes and air cooled to room temperature. The composite sheet is then treated with hydrochloric acid to leach the calcium carbonate from the composite. Once free of calcium carbonate, the sheet is washed with water to remove all traces of acid. The average pore size of each layer replicates the particle size of the calcium carbonate employed as the pore former in each polytetrafluoroethylene filtering membrane layer. The size of the pores produced is directly proportionate to the size of the pore former and can range from sub-micron sizes to macro-size particles dependent entirely upon the ability to process leachable particulate suitable materials.

### EXAMPLE X

This example demonstrates the addition of a filler component to provide electrical resistivity and more particularly, a structure made according to this invention which is not sintered. Surprisingly, the composition exhibits anisotropic resistant heating characteristics. The heating characteristics were found to be essentially constant over the entire multi-directional planar oriented structure even when there is a variation in the current flow. Customarily, the resistance of carbon decreases as the temperature is increased. Surprisingly, the resistance of the structure made by this invention remains substantially constant as the temperature is increased. 2,000 ml of Isopar H are added to the chamber of a high intensity stirrer and heated to 125 degrees Centigrade. 150 grams of “Teflon” 6 coagulated dispersion resin (DuPont) is added to the stirring vessel and exposed to the high streamlined shear of the stirrer for three (3) minutes to produce a fibrous form of “Teflon” 6. An additional 2,000 ml of Isopar H is added, followed by 80 grams of 0.03 micron carbon black (Vulcan 72). The above mixture is stirred for one (1) minute, followed by the addition of 270 grams of silica (Opal Supersil), average particle size, 7 microns. The mixture is stirred for an additional thirty (30) seconds to produce a homogeneous slurry. The slurry is then poured onto a paper mold containing a Whatman No. 1 filter paper. A vacuum of approximately twenty-five inches (25″) of mercury is applied to remove the liquid and settle the mixture and form a “fiber mat” on the filtering media. Complete removal of residual liquid is accomplished by heating in a circulating air oven at a temperature of 200 degrees Centigrade or higher (but should never approach the 342 degree Centigrade melting point of the fluoropolymer). The composite sheet is then trimmed to the desired dimensions and positioned on wallboard. A cooper electrode is placed at either end and a sheet of polypropylene is placed over the top of the lay-up. The lay-up is heated to 100 degrees Centigrade and pressed at 350 PSI for ten (10) minutes to produce a bond. The finished composition is unsintered. The resistance of the sandwich as calculated by Ohm's law is essentially constant. The resistance of carbon increases under similar conditions. The resistance of the sandwich surprisingly remained essentially constant as the temperature is increased.

### EXAMPLE XI

This example illustrates true reinforcement of PTFE fluorocarbon resin by the addition of one half inch (½″) to three quarter inch (¾″) superfine diameter glass fibers. One part of the solids component consists of twenty-five percent (25%) one half inch (½″) to three quarter inch (¾″) “Beta Fiberglass”. The other portion is seventy-five percent (75%) “Teflon” 7. Both parts are added to twenty (20) parts of Isopar H at 125 degrees Centigrade and sheared in a high intensity stirrer for three (3) minutes. The slurry produced is further diluted with thirty-five (35) parts of Isopar H and stirred for an additional one (1) minute to produce a thin homogeneous slurry. The thinned slurry is treated the same as in Example II. After sintering, the sheet has an average tensile strength of 6,000 PSI and an average elongation of five percent (5%) when measured in any direction. The tensile modulus is 250,000 PSI. Ordinarily, fillers in the art process reduce the tensile properties by an amount proportional to the percentage of filler added. The tensile strength in this example is surprisingly equal to or better than that of one hundred percent (100%) PTFE sheet.

The above examples of this invention portray the primary and preferred embodiments of this invention. It will become apparent to anyone skilled in the art that changes and modifications in implementation may be made without departing from the spirit and scope of this invention presented in the appended claims.

Having thus described my invention, I claim:

1. A process for making polytetrafluoroethylene resin multi-directional planar oriented structures comprising the steps of:
a) applying high velocity shearing force to particulate polytetrafluorothylene (PTFE) resin in a wetting liquid at a temperature of approximately 125 degrees Centigrade for three (3) to five (5) minutes to produce a micro-filter slurry;
b) diluting further the slurry in additional wetting liquid to separate the micro fibers and form a homogeneous mixture of micro fibers;
c) depositing the homogeneous mixture of micro fibers on a porous surface to remove liquid and form a mat of PTFE micro fibers;
d) drying the mat of PTFE micro-fibers at a temperature not exceeding 342 degrees Centigrade;
e) compressing the mat of PTFE micro fibers at moderate pressure below 1,000 PSI at a temperature ranging between 175 degrees and 342 degrees Centigrade; and
f) sintering the sheet of PTFE micro fibers at a temperature of approximate 380 degrees Centigrade for approximately thirty (30) minutes to one (1) hour to form a multi-directional planar oriented structure of PTFE micro fibers.

2. The process of claim 1 wherein the wetting liquid is Isopar H.

3. The process of claim 1 wherein the step of depositing the homogeneous mixture of micro fibers, on a porous surface is assisted by a vacuum of approximately twenty-five (25) to twenty-eight (28) inches of mercury.

4. The process of claim 1 wherein the drying step is performed in an air circulating oven or under a bank of infrared heaters.

5. The process of claim 1 wherein the Step “e” is accomplished between smooth surface metal plates.

6. The process of claim 1 wherein at least one (1) additional micro fibrous material is added to the slurry in Step “b”.

7. The process of claim 1 wherein the non-fibrous filler is added during Step “b” up to ninety-five percent (95%) of the total solids volume.

8. The process of claim 7 wherein the non-fibrous filler is calcium carbonate.

9. The process of claim 1 wherein mica is added to the slurry in Step “b” to improve the resistance of PTFE resin to corona discharge in electrical applications.

10. A multi-directional planar oriented structure of micro fiberous PTFE resin comprised of at least one (1) sheet of unsintered PTFE.

11. The multi-directional planar oriented structure of micro fiberous PTFE resin of claim 10 wherein the at least one (1) sheet of PTFE is combined with the at least one (1) other similar sheet of PTFE containing at least one (1) filler and fused together to form a composite structure.

12. The structure of claim 11 wherein the filler is calcium carbonate.

13. The structure of claim 11 wherein the filler is mica.

14. The structure of claim 11 wherein the filler is silicon carbide particles or micro fibers.

15. The structure of claim 11 wherein the filler is silicon carbide micro fibers.

16. An unsintered uniaxially-oriented micro fibers made of unsintered PTFE resin produced according to Step “a” of claim 1.
